(19) United States
(12) Patent Application Publication
(10) Pub. No.: US 2007/0100845 A1
(43) Pub. Date: May 3, 2007

(54) Customer relationship management integration system and method

(76) Inventors: Juergen Sattler, Wiesloch (DE); Joachim Gaffga, Wiesloch (DE)

Correspondence Address: KENYON & KENYON LLP, 1500 K STREET N.W., WASHINGTON, DC, 20005, US

(21) Appl. No.: 11/261,778

(22) Filed: Oct. 31, 2005

(51) Int. Cl. G06F 7/00

(52) U.S. Cl. 707/100

(57) ABSTRACT

This invention is directed to a customer relationship management integration system and method in an online and an offline mode of operation. In this invention, CRM customer data, which is generally incompatible with groupware data, is manipulable by the groupware client. Customer data that can be fitted within standard groupware data structures is synchronized with the data structures for manipulation by standard groupware tools. Customer data that can not be fitted within standard groupware data structures is manipulable by special customer tools that may be used within the groupware client.

### BACKGROUND

Mobile technology, such as laptop computers and personal digital assistants (PDAs), enables workers to access customer data at any time and place. Groupware clients, such as Microsoft Outlook™, IBM Lotus Notes™, and any Open Source groupware, are popular software packages used to do so through such tools as email, calendars, task lists, and business contact lists.

However, a limitation of these groupware clients is that they are structured to send and receive data in a particular format of a particular type and are not amenable to handling other data formats or types. Hence, to access customer data that the groupware client does not normally handle, the worker must separately access other applications and/or databases associated with that customer data. The worker wastes valuable time and effort running multiple applications to access data across these applications and mentally coordinating the data. Moreover, the customer data itself becomes disparate, with no linkage between that accessible by the various applications.

Since data accessed by different applications is often incompatible, duplicate records must be kept so that workers using different applications have the same data, albeit in different formats or types. Such a practice takes up memory that, though large in most database systems, is not infinite. This problem is magnified in mobile devices, which typically have very limited memory, such that duplicate records are impractical.

Another issue is how to update customer data from incompatible applications. Traditionally, updates are made by running each application separately and modifying the customer data using the compatible application. This also wastes valuable time and effort for the worker who has to run multiple applications, particularly when the updates are to duplicate records.

Accordingly, there is a need in the art for a system and method to integrate customer data from generally incompatible multiple sources to be accessible in a seamless manner on computers, in general, and on mobile devices, in particular.

### BRIEF DESCRIPTION OF THE DRAWINGS

FIG. 1 illustrates a generic system for implementing an embodiment of the present invention.

FIG. 2 illustrates the data flow of a system for implementing an embodiment of the present invention.

FIG. 3 is a flowchart of a method according to an embodiment of the present invention.

FIG. 4 is a flowchart of another method according to an embodiment of the present invention.

FIG. 5 is a screenshot illustrating data integration according to an embodiment of the present invention.

### DETAILED DESCRIPTION

Embodiments of the present invention may integrate customer data from multiple sources so that a user may access, update, store, and otherwise manipulate this data using a single application. This advantageously saves the user time and effort in keeping up to date on the most recent and accurate data, either in an online or an offline mode of operation.

Embodiments of the present invention may be particularly useful in customer relationship management (CRM) systems. CRM systems are developed to provide direct customer contact throughout the entire life cycle of the customer-business relationship, e.g., from initial marketing to customer sales to post-sale customer service. A typical CRM system manages customer data, such as financial and business plans, product lines, contact information, and any other data associated with a customer in order to effectively provide direct contact. Therefore, quick and easy access to this data at any time and place by workers who deal with the customer is very important.

Groupware clients generally provide contact information, asynchronous communication, meeting setup, and to-do lists, via respective contact, email, calendar, and task tools. Using email, a user may exchange messages asynchronously with others. The messages may include text, file attachments, graphics, etc. Through the calendar, the user may set up and keep track of customer appointments. Using the contact tool, the user may store and retrieve contact information of business associates, customers, businesses, etc. The task tool may provide the user with customer to-do lists.

These groupware clients, however, do not typically provide financial and business plans, product lines, and other sales-related data. This type of customer data is typically provided by a CRM application. Hence, the customer data generated by the CRM application is often incompatible with the groupware client.

In some instances, the CRM customer data provides the same information as client data, e.g., business contact information, meeting schedules, and business activities. However, the formats of the information are different, such that neither the client nor the CRM application can view the other's information, resulting in duplicate records as discussed above. A solution to this problem is provided in embodiments of the present invention. Integrating the groupware client's data with the CRM application's data for access by the most-used client advantageously eases a worker's data gathering activities and a database's redundant data storage.

In one embodiment, a method is provided for the data integration. In this method, a groupware server, e.g., Microsoft Exchange Server™ or IBM Lotus Domino Server™, may synchronize incompatible customer data with a groupware client, e.g., Microsoft Outlook™ or IBM Lotus Notes™, so that the customer data may be managed by the client using the client's standard tools or using special tools executable by the client. The method may operate in an online mode and an offline mode. In an online mode, the client may manipulate the customer data stored in a customer database in real-time. In an offline mode, the client may manipulate a replicated copy of the customer data stored in the memory of the offline device and update the customer data in the customer database when the client device reconnects to the customer database.

In another embodiment, a system is provided for the data integration. In this system, a memory may store customer data that is incompatible with a groupware client. A system processor may provide access to that incompatible customer data using the groupware client, in which the processor provides access to a customer folder containing the customer data, determines whether the customer data fits within a standard data structure of the groupware client, if so, provide the customer data via the standard data structure, and, otherwise, provide the customer data via a special data structure.

These embodiments may advantageously be provided in either an online or an offline mode of operation.

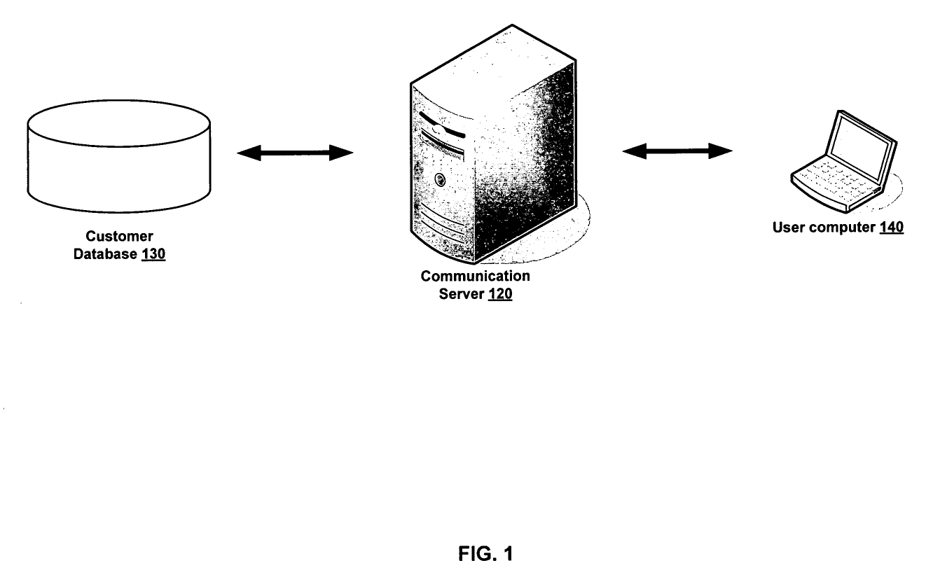

FIG. 1 illustrates a system for implementing an embodiment of the present invention. The system may include a communication server 120 in communication with a user computer 140 and a customer database 130. These components may be connected via any communication network. The user computer 140 may be a desktop device or a mobile devise through which the user may execute a groupware client to send and receive data, which may include the standard data and the incompatible customer data according to embodiments of the present invention. The user computer 140 may operate in either online or offline mode. The customer database 130 may be a storage medium for the incompatible customer data. The customer database 130 may also store the standard data managed by the groupware client. The communication server 120 may include a groupware server to provide access by the groupware client to the standard data and the incompatible customer data. The communication server 120 may also manage the integration of the standard and customer data to be accessed by the groupware client.

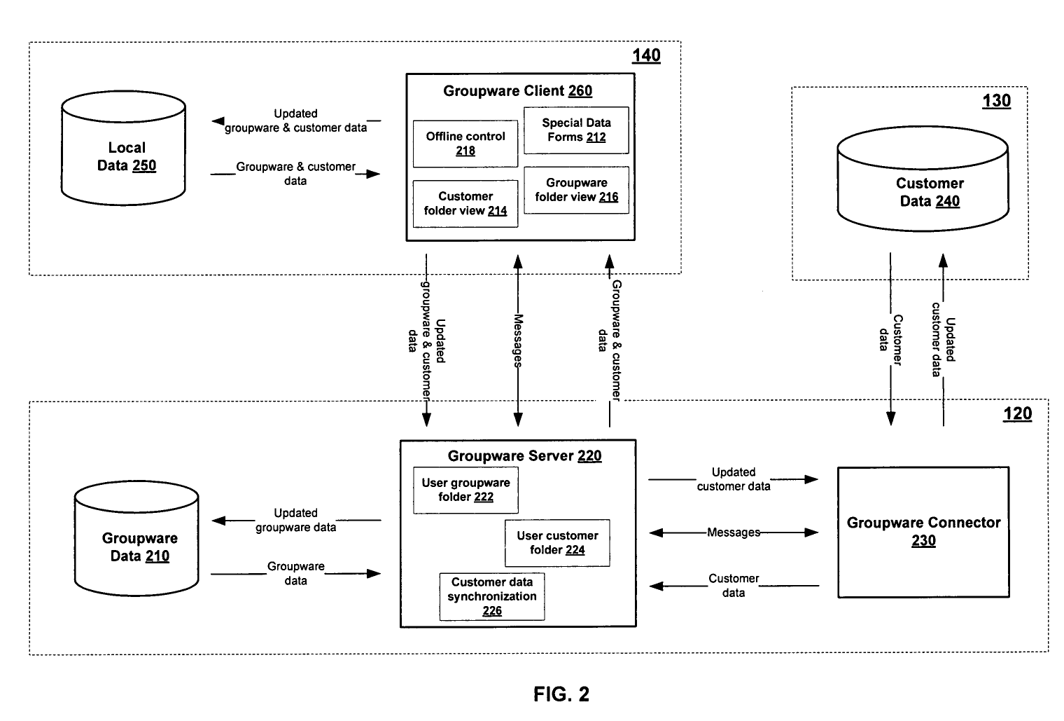

FIG. 2 illustrates the data flow of a system for implementing an embodiment of the present invention. The communication server 120 may include groupware server 220, groupware connector 230, and groupware data 210. The groupware server 220 may comprise software that provides access by groupware client 260, to customer data 240 and groupware data 210. Server 220 may include user groupware folder 222, user customer folder 224, and customer synchronization tool 226. Each user that has groupware client 260 on the user's computer has a user groupware folder 222 on server 220. The groupware folder 222 may include any groupware data to be accessed by the user's groupware client 260. For example, a user's incoming email may be stored in the user's groupware email folder on server 220. When the user opens groupware email, groupware may access the user's email folder on server 220, extract the data structure comprising the incoming email therefrom, and then parse the data structure to display the email to the user. Similar groupware folders may exist on server 220 for contact information, tasks lists, and calendar data.

Similarly, each user that has groupware client 260 on the user's computer has a user customer folder 224 on server 220. The customer folder 224 may include any customer data, that is normally incompatible with groupware, to be accessed by the user's groupware client 260. The customer data may include CRM data copied from the CRM system customer database 130.

To access the customer data using groupware, server 220 may execute the customer synchronization tool 226. Synchronization tool 226 may synchronize the customer data in customer data structures in customer folder 224 with the standard groupware data structure, if possible, and provide the synchronized data structure to groupware for displaying using groupware tools. For example, CRM business partner contact information, stored in customer folder 224, may be the same as groupware contact information. As such, the business partner contact information from customer folder 224 may be linked by tool 226 to fit the same groupware data structure as groupware contact information. Hence, the user may view the business partner contact information using groupware contact.

Synchronization tool 226 may also be used to synchronize updates to groupware data and customer data. When the user updates groupware data using groupware tools, server 220 may determine whether the updated groupware data corresponds to customer data. As such, server 220 may store the updated groupware data into user groupware folder 222 in the standard groupware data structure. Synchronization tool 226 may be used to link the updates to corresponding customer data structures in user customer folder 224, such that the updates are made to the customer data.

If the customer folder 224 includes customer data that may not fit into groupware data structures, then server 220 may include special customer data structures that are recognizable by special customer data tools added to groupware.

The user folder 222 may access groupware data 210 stored on communication server 120 or, alternatively, on an external database. The user folder 224 may assess customer data 240 stored on a CRM database.

The groupware connector 230 on server 120 may comprise software to facilitate communication between the CRM system and the groupware server 220 for transferring the incompatible customer data therebetween. The connector 230 may use event triggers, for example, to initiate data transfers therebetween.

The user computer 140 may include groupware client 260and local data 250, which is replicated groupware data 210 and replicated customer data 240, for use when the user computer 140 operates offline. Groupware client 260 may include special data forms 212, customer folder view tool 214, groupware folder view tool 216, and offline control 218. Groupware folder view tool 216 may be used to access standard groupware data. Tool 216 may access user groupware folder 222 on server 220 to retrieve and display groupware data and synchronized customer data. Similarly, groupware tool 216 may be used to create and send new groupware data to groupware folder 222 for storage. Customer folder view tool 214 may be used to access customer data that is incompatible with groupware data structures. Groupware tool 214 may be used to create and send new customer data to customer folder 224 on server 220.

Special data forms 212 may be used to create customer data to be stored in customer folder 224. These forms 212 may be related to customer data structures that are stored in customer folder 224. The forms 212 may include fields corresponding to data structure elements into which a user may input customer data.

Offline control 218 may be used when the user computer 140 operates offline. Offline control 218 may provide the same capabilities as the groupware server 220 in managing the groupware and customer data to be manipulated by the groupware client 260 when offline.

In an embodiment of the present invention, data may flow as follows. In online mode, a user may open groupware client 260 on the user computer 140. The user may send a message to groupware server 220 on communication server 120 to access groupware and/or customer data. Groupware server 220 may retrieve the requested groupware data 210 from folder 222 via server memory. Groupware server 220 may retrieve the requested customer data from folder 224 by sending a message to groupware connector 230 to retrieve the requested customer data from customer database 130. Groupware connector 230 may forward the retrieved customer data to groupware server 220. Groupware server 220 may send the requested groupware and/or customer data to user computer 140 for viewing and manipulating. Groupware client 260 may then store a replicated copy of the groupware and/or customer data in local memory as local data 250.

The user may input new groupware and/or customer data using groupware. The user may send a message to exchange server 220 that groupware client 260 is sending updated groupware and/or customer data. Groupware client 260 may send the updated data to groupware server 220. Groupware server 220 may store the groupware data into user groupware folder 222 and make any corresponding updates to customer data in user customer folder 224. Groupware server 220 may store updates to customer data into user customer folder 224. Groupware server 220 may send a message to groupware connector 230 that updated customer data is to be stored in customer database 130. Groupware server 220 may then send the updated customer data to groupware connector 230 that then stores the updated customer data into customer database 130.

Prior to going offline, groupware client 260 may store replicated copies of groupware and customer data into local memory on the user computer 140 as local data 250. When offline, the user may open groupware client 260 on the user computer 140. Groupware may include local versions of customer synchronization tool 226, user groupware folder 222, and user customer folder 224. As such, the user may use groupware offline control 218 to access the replicated copies of groupware and customer data stored in local memory. The user may also use groupware to update groupware and customer data. The updated data may be stored in local memory until the user computer 140 connects online to communication server 120 and customer database 130. When reconnected, groupware client 260 may send a message to groupware server 220 that updated data is to be sent. Groupware client 260 may then send the updated data as described above.

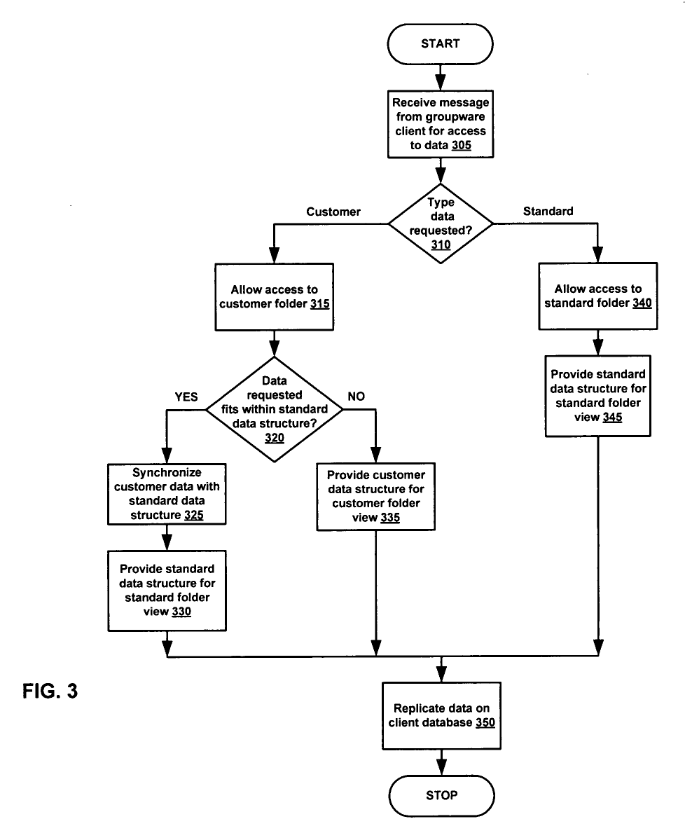

FIG. 3 is a flowchart of a method by a groupware server according to an embodiment of the present invention. The groupware server 220 may receive (305) a message from the groupware client 260 for access to data. The server 220 may determine (310) whether access is requested for standard client data or for special customer data, e.g., CRM data.

If the access is for standard client data, the server 220 may allow (340) the client 260 to access the standard client folder containing the data. The server 220 may then provide (345) the data in the standard data structure for display and manipulation by a standard client folder tool implemented on client 260.

If the access is for special customer data, the server 220 may allow (315) the client 260 to access the customer folder containing the data. The server 220 may determine (320) whether the customer data to be accessed may be fitted into a standard client data structure. If not, the server 220 may provide (335) the data in a special customer data structure for display and manipulation by a special customer folder tool implemented on client 260.

If the customer data to be accessed may be fitted into a standard client data structure, the server 220 may synchronize (325) the special customer data structure containing the data with a standard client data structure by linking the corresponding fields of the two data structures. The server 220 may then provide (330) the data in the standard data structure for display and manipulation by a standard client folder tool implemented on client 260.

The client 260 may replicate (350) the data and store it in local memory on the user computer 140.

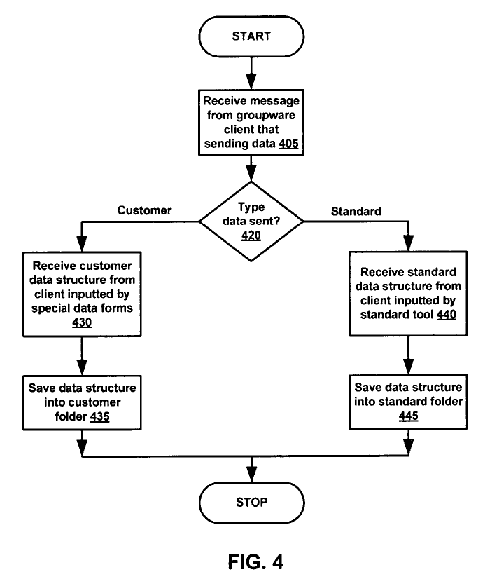

FIG. 4 is a flowchart of another method by a groupware server according to an embodiment of the present invention. The groupware server 220 may receive (405) a message from the groupware client 260 that the client 260 is sending data to be either stored or sent to another server. The server 220 may determine (420) whether the data sent by the client 260 is standard client data or special customer data.

If the data is standard client data, the server 220 may receive (440) standard data structures containing the data, which was inputted using a standard client input tool. The server 220 may save (445) the data structure into a standard client folder. Alternatively, the server 220 may forward the data structure to another user's client folder or to another system.

If the data is special customer data, the server 220 may receive (430) special customer data structures containing the data, which was inputted using the special client forms described above. The server 220 may save (435) the data structure into a special customer folder. Alternatively, the server 220 may forward the data structure to another user's customer folder or to another system.

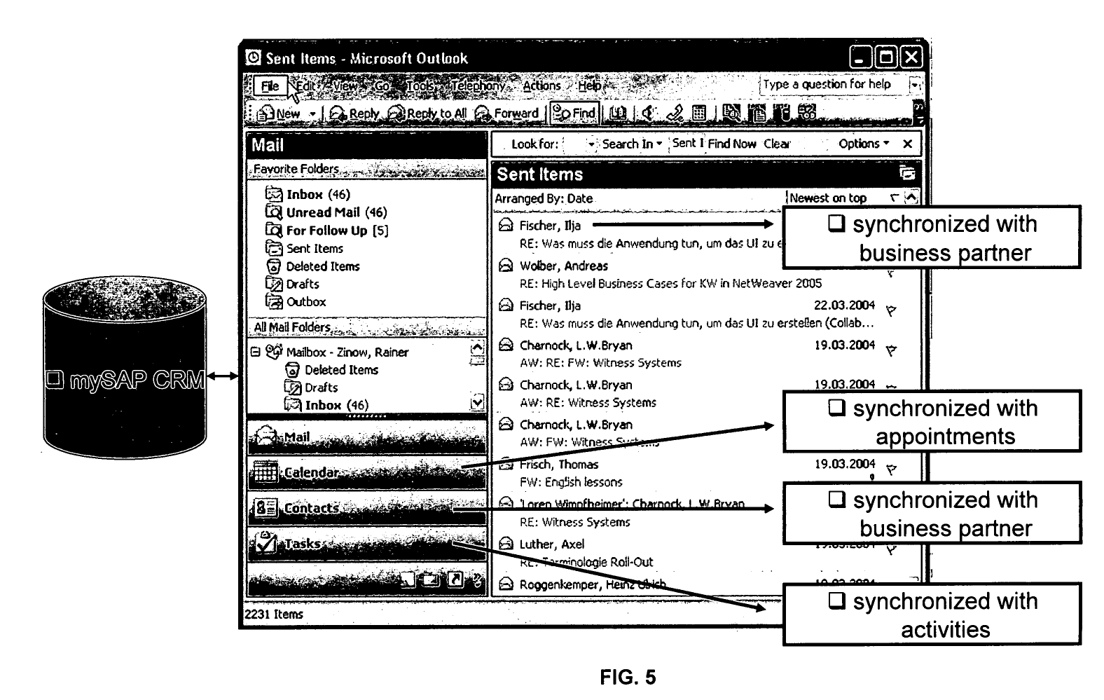

FIG. 5 is a screenshot illustrating data integration according to an embodiment of the present invention. This figure shows a Microsoft Outlook™ interface as seen by a user on the user computer 140. In this integration, CRM data includes business partner information, appointments, and activities that are stored in the customer database, mySAP CRM. The Microsoft Exchange Server™ 220 of an embodiment of the present invention may integrate this CRM data with the Outlook tools indicated in the figure.

For example, the email tool in Outlook may be synchronized to the business partner information in the CRM database, such that email addresses may be retrieved from the business partner information in the CRM database to populate the “To” field of an email message, for example. The contact tool in Outlook may be synchronized with the business partner information, such that updates made in Outlook may be transmitted to the CRM database, for example. Similarly, the task tool in Outlook may be synchronized with activities in the CRM database and the calendar tool in Outlook may be synchronized with appointments in the CRM database. Accordingly, when access is made in Outlook to the Outlook tools, the CRM data may be accessed therethrough. Or, when updates are made in Outlook or in the CRM database, the updates may be reflected in the other also.

In this figure, the CRM data synchronizes naturally to the Outlook tools. However, in an embodiment where there is no such synchronization, the exchange server 220 may provide a new customer folder on Outlook to view the CRM customer data. The new customer folder may be displayed within the “Folder List” of Outlook and clicked on to access the data. The folder may also provide links to executable CRM routines operable on the folder, e.g., data input routines, open file routines, etc.

Several embodiments of the invention are specifically illustrated and/or described herein. However, it will be appreciated that modifications and variations of the invention are covered by the above teachings and within the purview of the appended claims without departing from the spirit and intended scope of the invention.

1. A method comprising:
in response to a request to access customer data on a groupware client, determining whether the customer data fits within the client's data structure;
synchronizing the customer data that fits with the client's data structure; and
allowing access by the client to the synchronized customer data using the client's data structure for manipulation by the client using the client's data tools.

2. The method of claim 1, wherein the determining comprises:
determining whether the client's data structure has data fields for holding client data corresponding to the customer data; and
if so, identifying the customer data as fitting within the client's data structure.

3. The method of claim 1, wherein the synchronizing comprises:
linking the customer data to data fields of the client's data structure that would hold client data corresponding to the customer data.

4. The method of claim 1, further comprising:
allowing access by the client to customer data that does not fit using a special data structure for manipulation by the client using special data tools.

5. The method of claim 1, further comprising:
allowing access by the client to client data via the client's data structure for manipulation by the client using the client's data tools.

6. The method of claim 1, further comprising:
providing a user customer data folder for each user of the client to store customer data that fits and that does not fit for access by the client; and
providing a user client data folder for each user of the client to store client data for access by the client, wherein the client data fits within the client's data structure.

7. The method of claim 1, further comprising:
operating in an online mode to manipulate the customer data in real-time.

8. The method of claim 7, further comprising:
in the online mode,
receiving a request from the client to send the customer data, and
retrieving the customer data from a customer database in communication with the client.

9. The method of claim 7, further comprising:
in the online mode,
identifying to which customer database to store customer data updates, and
sending the updates to the identified database.

10. The method of claim 1, further comprising:
operating in an offline mode to manipulate a replicated copy of the customer data resident on the client computer.

11. The method of claim 10, further comprising:
in the offline mode,
receiving a request from the client to send the customer data, and
retrieving the replicated copy of the customer data from memory of the client computer.

12. The method of claim 10, further comprising:
in the offline mode,
storing customer data updates on memory of the client computer.

13. A system comprising:
a memory for storing customer data, and a processor in communication with the memory, the processor configured to:
in response to a request for access to customer data, provide access to a customer folder containing the customer data,
determine whether the customer data fits within a standard data structure,
if so, allow access the customer data within the standard data structure, and
otherwise, allow access the customer data within a special data structure.

14. The system of claim 13, wherein the processor is further configured to:
in response to a request to send customer data, provide access to a customer folder to receive the customer data.

15. A method comprising:
in response to a request for a groupware client to send customer data, receiving the customer data, wherein the customer data was created using special data forms on the groupware client; and
storing the received customer data into a customer folder.

16. The method of claim 15, wherein a special data form includes fields corresponding to elements of a customer data structure, wherein the customer data is inputted into the fields.

17. The method of claim 15, wherein the customer data has a format that does not fit with a format of client data normally created by the client.

18. The method of claim 15, further comprising:
receiving client data having a standard format; and
storing the received client data into a standard client folder.

19. A method comprising:
receiving data from a groupware server in response to a request by a groupware client for the data;
determining whether the received data is customer data;
if the received customer data is in a format recognizable by the client's standard data tool, manipulating the received customer data with the standard data tool; and
otherwise, manipulating the received customer data with a special customer data tool.

20. The method of claim 19, further comprising:
using a special data form to send customer data from the client to the server, wherein the special data form includes fields for inputting customer data, the fields being converted to a customer data structure.
